(19) United States
(12) Patent Application Publication
(10) Pub. No.: US 2026/0083047 A1
(43) Pub. Date: Mar. 26, 2026

(54) GENERATING A NUTRIENT USE EFFICIENCY METRIC FOR USE IN CONTROLLING AGRICULTURAL OPERATIONS

(71) Applicant: Deere & Company, Moline, IL (US)

(72) Inventors: Dylan J. ROTH, Kyle, TX (US); Christopher J. HICKS, Bondurant, IA (US); William Z. CHEN, Brooklyn, NY (US); Kimberly A. DUHN, Grimes, IA (US); Stephen R. CRANE, Des Moines, IA (US); Matthew P. STEMPER, Johnston, IA (US)

(21) Appl. No.: 18/893,570

(22) Filed: Sep. 23, 2024

(51) Int. Cl. A01C 21/00

(52) U.S. Cl. CPC A01C 21/007; A01C 21/005

(57) ABSTRACT

Geo-referenced nutrient use data indicative of nutrients applied to a field is obtained along with geo-referenced yield data which is indicative of crop yield in the field. A set of geo-referenced nutrient use efficiency (NUE) metric values is generated based on the nutrient use data and the yield data. Based upon the geo-referenced NUE metric values, a control signal is generated to control an agricultural system via machine settings adjustments (i.e., nutrient prescriptions) on the agricultural machine as it travels through a field.

### FIELD OF THE DESCRIPTION

The present description relates to agricultural operations. More particularly, the present description relates to generating a geo-referenced nutrient use efficiency metric for use in controlling the application of nutrients to a field.

### BACKGROUND

There is wide variety of different types of agricultural equipment. Some such equipment is used to apply nutrients to a field.

For example, nutrients can be applied when a crop is planted, by applying nutrients through row units on a planting machine. Nutrients can also be applied using a side dress bar. Nutrients can be sprayed on a field, dropped or otherwise deposited in a furrow, or between rows, or in other ways.

Nutrients may be applied to a field in different ways over a period of years. For instance, in some years, nutrients may be applied using a first product, at a first application rate. Nutrients may be applied in other years using a second product or even more products, all at different rates. The products may have different content levels of different nutrients. These different nutrient applications may aggregate the volume of nutrients in the field over time or over different application operations. However, nutrients may also be lost over time through a variety of different natural processes.

The discussion above is merely provided for general background information and is not intended to be used as an aid in determining the scope of the claimed subject matter.

### SUMMARY

Nutrient use data indicative of nutrients applied to a field is obtained along with yield data which is indicative of crop yield in the field. A nutrient use efficiency (NUE) metric value is generated based on the nutrient use data and the yield data. A control signal is generated to control an agricultural system based upon the NUE metric value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial block diagram, partial schematic diagram of an agricultural system.

FIG. 2 is a block diagram showing portions of the agricultural system shown in FIG. 1 in more detail.

FIG. 3 is a flow diagram showing one example of the operation of an agricultural system.

FIG. 4 shows one example of a user interface representation illustrating a geo-referenced nutrient use efficiency value.

FIG. 5 shows another example of a user interface representation illustrating a nutrient use efficiency value.

FIG. 6 is a flow diagram showing one example of the operation of an agricultural system in generating a nutrient prescription for a field.

FIG. 7 is a block diagram showing one example of an agricultural system deployed in a remote server environment.

FIGS. 8, 9, and 10 show examples of mobile devices that can be used in architectures and systems described herein.

FIG. 11 is a block diagram showing one example of a computing environment that can be used in architectures and systems shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, nutrients may be applied at various rates at different times. The nutrients may affect the crop yield in the field. Both over application of nutrients and under application of nutrients can be problematic. For instance, when nutrients are over applied, this can result in inefficiencies, in which extra nutrients are applied to the field but do not result in a corresponding increase in yield. When nutrients are under applied, this may also result in inefficiencies in that the desired crop yield may not be obtained due to insufficient nutrient application.

Therefore, in one example, the present description describes a nutrient processing and control system that accesses nutrient application data indicative of nutrients that have been applied to a field as well as yield data indicative of the crop yield in field. Based upon the nutrient application data, and the yield data, the nutrient processing and control system generates a nutrient use efficiency (NUE) metric value indicative of the efficiency of nutrient use in the field. The NUE metric value may be expressed in terms of units of applied nutrients per unit of yield. The NUE metric value can be geo-referenced to the field and used to plan and control nutrient application.

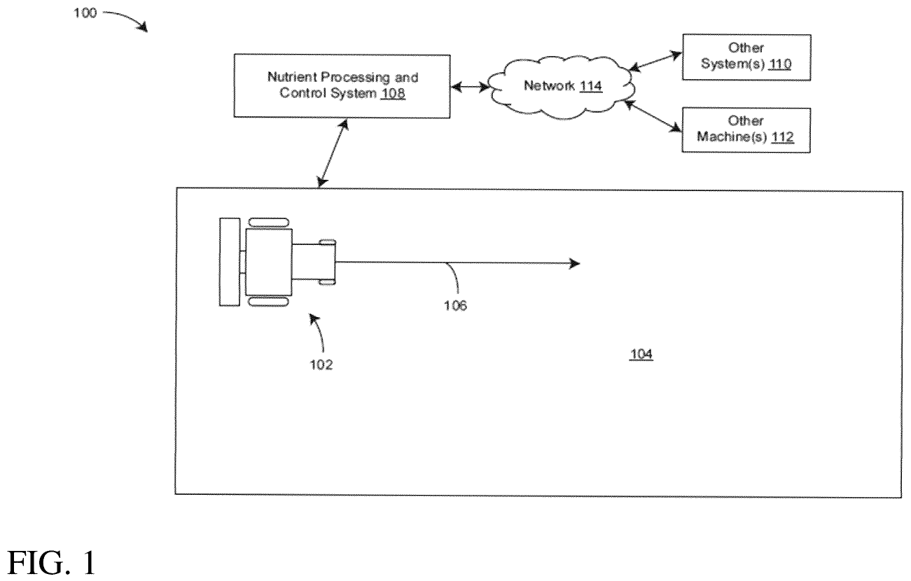

FIG. 1 is a partial pictorial, partial block diagram of one example of an agricultural system 100. System 100 shows one example of an agricultural machine 102 operating in a field 104. Agricultural machine 102 travels in the direction generally indicated by arrow 106 and applies nutrients to the field 104.

FIG. 1 also shows that, in one example, agricultural system 100 includes nutrient processing and control system 108 which may communicate with other systems 110 and other machines 112 over a network 114. Network 114 may be a wide area network, a local area network, a cellular communication network, a Bluetooth network, a Wi-Fi network, or any of a wide variety of other networks or combinations of networks.

In FIG. 1, agricultural machine 102 is shown as a tractor pulling a planter with row units. The row units are configured to apply nutrients to field 104. The nutrients may be applied by the row units depositing nutrients in a furrow, or adjacent to a furrow (such as by using a side dress bar). Alternative machines and/or methods may also be used to apply nutrients to a field (i.e., sprayer, dry spreader, etc.).

As discussed above, it can be difficult to identify the volume of nutrients which should be applied to field 104. For example, it can be difficult to know the volume of new nutrients that should be applied to field 104 based upon the volume of nutrients that have been applied to field 104 over prior years and based on the change in yield for each additional application of nutrients. Similarly, different products have different nutrient content. Therefore, it can be difficult to determine a rate of application that is to be used by agricultural machine 102 given the different content of nutrients in the different products, and the different volumes of nutrients that have been applied to field 104 historically.

In addition, identifying the optimal volume of nutrients to apply can be difficult because it may be that fewer or more nutrients should be applied to field 104 to most efficiently enhance the crop yield in field 104.

Therefore, in one example, nutrient processing and control system 108 accesses historical nutrient application data indicative of nutrients that have historically been applied to field 104, as well as yield data indicative of the crop yield in field 104. The yield data can be historical yield data from prior crop growing seasons, or current estimated or measured yield data for the crop(s) in field 104. The estimated yield data may be estimated based upon aerial images, such as based on satellite imagery showing NDVI values, or based on other information. The measured yield data can be generated during harvesting of field 104.

Based upon the historical and/or current nutrient application data, and the historic and/or current yield data, nutrient processing and control system 108 generates a nutrient use efficiency (NUE) metric value indicative of the efficiency of nutrient use in field 104. The NUE metric value may be expressed in terms of units (e.g., pounds/acre) of nutrients per unit of yield (e.g., bushels/acre) in field 104, or in other ways.

The NUE metric value generated for field 104 may be geo-referenced so that different portions of field 104 have different NUE metric values calculated for them. The geo-referenced NUE metric values can then be used by nutrient processing and control system 108 to generate a prescription that can be downloaded to agricultural machine 102 or to a different machine, and which can be used by the machine to apply product(s) to field 104. The prescription may account for the content of nutrients in different products that may be used by agricultural machine 102 and may thus define an application rate that varies as agricultural machine 102 moves over field 104.

In one example, nutrient processing and control system 108 also obtains a target NUE value for field 104. The target NUE value may be input by an operator, calculated, or a default value, or obtained in other ways. Nutrient processing and control system 108 may then compare the target NUE value to the geo-referenced NUE metric values generated for field 104. System 108 can also generate a prescription for application of product(s) to field 104 based upon the comparison of the target NUE values to the geo-referenced NUE metric values generated for field 104. For instance, if the NUE metric values calculated for field 104 show that certain portions of field 104 should have a greater quantity of product applied (e.g., to increase the nutrients applied at that location), then the prescription may indicate a higher application rate at that portion of the field 104. If the comparison indicates that certain portions of the field 104 should have less product applied, then the prescription may indicate that less or no product is to be applied to those locations of field 104, to more closely adhere to the target NUE metric values for field 104.

Nutrient processing and control system 108 can also communicate with other systems 110 and other machines 112 over network 114. For instance, the other systems 110 may be farm manager systems, vendor systems, manufacturer systems, planning systems, logistics systems, or other systems. Other machines 112 may be machines that are to apply product(s) to field 104 in the future, or other machines. Further, the information obtained and generated by nutrient processing and control system 108 may be stored for future use in other systems 110 or processed in other ways.

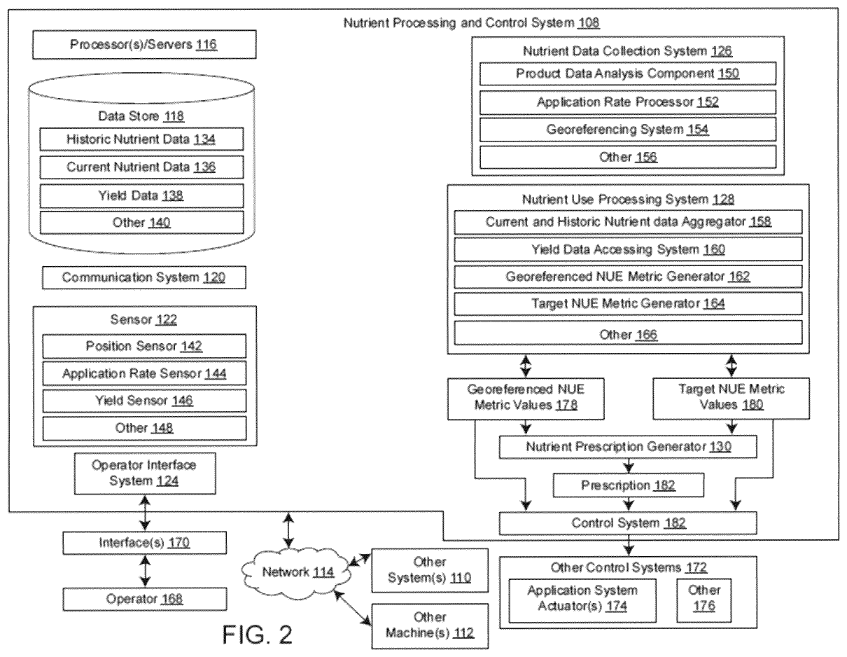

FIG. 2 is a block diagram showing one example of nutrient processing and control system 108 in more detail. Some items in FIG. 2 are similarly numbered to those shown in FIG. 1, and those items are similarly numbered. It will also be noted that the items in nutrient processing and control system 108 may be all located at a single location (such as on agricultural machine 102, in other systems 110, etc.) or the items in nutrient processing and control system 108 can be dispersed among various locations in agricultural system 100 or elsewhere. The items in nutrient processing and control system 108 are shown in a single location in FIG. 2 for the sake of example only.

In the example shown in FIG. 2, nutrient processing and control system 108 includes one or more processors or servers 116, data store 118, communication system 120, one or more sensors 122, operator interface system 124, nutrient data collection system 126, nutrient use processing system 128, nutrient prescription generator 130, and control system 132. Data store 118 can include historic nutrient data 134, current nutrient data 136, yield data 138, and any of a wide variety of other data 140. Sensors 122 can include position sensor 142, application rate sensor 144, yield sensor 146, and any of a wide variety of other sensors 148. Nutrient data collection system 126 can include product analysis component 150, application rate processor 152, geo-referencing system 154, and other items 156. Nutrient use processing system 128 can include current and historic nutrient data aggregator 158, yield data accessing system 160, geo-referenced NUE metric generator 162, target NUE metric generator 164, and other items 166.

FIG. 2 also shows that operator 168 can interact with interfaces 170 generated by operator interface system 124. Thus, operator 168 can interact with interfaces 170 to control and manipulate portions of nutrient processing and control system 108 and possibly agricultural machine 102. Further, nutrient processing and control system 108 is shown interacting with other controllable systems 172. Such systems can include application system actuators 174 and other items 176. The application system actuators 174 may be actuators on agricultural machine 102 that are actuated to control the application of product(s) (e.g., the application rate of fertilizer) by agricultural machine 102 across field 104.

Before describing the overall operation of nutrient processing and control system 108 in more detail, a description of some of the items in nutrient processing and control system 108, and their operation, will first be provided. Historic nutrient data 134 can be data indicative of the volume of different nutrients that have been applied at different geographic locations in field 104 over time. Historic nutrient data 134 may thus include information indicating the volume of nitrogen, phosphorus, potassium, and/or other nutrients that have been delivered to field 104. Current nutrient data 136 may include data indicative of the volume of different nutrients that are currently being applied to field 104, or that have been applied to field 104 in recent history (e.g., during the current growing season), or other data. While the present description uses the term volume, the discussion applies to other values such as weight or mass. Yield data 138 may identify the historic crop yield at different locations in field 104, or current crop yield that is being measured by a harvester in field 104, or a future estimated yield that may be estimated based upon NDVI values or estimated in other ways.

Communication system 120 is configured to enable the communication of items in nutrient processing and control system 108 with one another and with other systems 110, other machines 112, or other entities over network 114. Therefore, communication system 120 may be a controller area network (CAN) bus and bus controller, a cellular communication system, a wide area network or local area network communication system, a near field communication system, a Bluetooth or Wi-Fi communication system, or any of a wide variety of other communication systems or combinations of systems.

Sensors 122 sense different variables and generate sensor signals indicative of the values of those sensed variables. Position sensor 142 senses a position of sensor 142 in a local or global coordinate system. Therefore, position sensor 142 may be a global navigation satellite system (GNSS), a cellular triangulation system, a dead reckoning system, or any of a variety of other location systems. Application rate sensor 144 generates an output indicative of a rate at which product is being applied by agricultural machine 102 to field 104. The application rate may be sensed in terms of mass flow rate, volume, weight, or another measure indicative of the rate at which product is being applied to field 104. Yield sensor 146 may be a sensor located on a harvester that senses yield, a sensor located on an unmanned aerial vehicle, such as an image capture sensor, a sensor located on a satellite which captures satellite images of field 104, or any of a wide variety of other sensors that sense a variable indicative of yield. Yield sensor 146 may also include a processing system (such as an image processing system) that is used to process the captured images to generate an output indicative of yield, based upon the processed images.

Operator interface system 124 can include operator interface mechanisms that generate interfaces 170 for operator 168. The interface mechanisms can include mechanisms that generate outputs for operator 168 and receive inputs from operator 168. Therefore, the interface mechanisms can include a steering wheel, joysticks, levers, linkages, buttons, knobs, pedals, and other mechanisms that receive inputs from operator 168. The interface mechanisms can also include a display screen, a touch sensitive display screen, a microphone, a speaker, or any of a wide variety of other mechanisms that generate audio, visual, and/or haptic outputs to operator 168 and/or that receive inputs from operator 168.

Nutrient data collection system 126 collects data that will be used by nutrient use processing system 128 to generate NUE metric values corresponding to field 104. Therefore, product data analysis component 150 may receive inputs corresponding to different products. Such product data may identify the content (in terms of percent or in other terms) of different nutrients that are in a product that has been applied, that is to be applied, or that is currently being applied, to field 104. Thus, product data analysis component 150 may retrieve the product data from data store 118 or received from an operator 168 through an interface 170. The product data can be retrieved or obtained from other systems 110 (such as product manufacturer or product vendor systems) over network 114 using communication system 120. The product data analysis component 150 can obtain product data in other ways as well.

Application rate processor 152 may receive an input from application rate sensor 144 and access the product data to generate an output indicative of the rate at which the different nutrients are currently being applied to field 104, or have been applied to field 104, or will be applied to field 104. For instance, application rate processor 152 can receive a particular location of machine 102 in field 104 as output by position sensor 142, a particular application rate in terms of pounds per acre output by application rate sensor 144, and a set of product data indicative of the nutrient content of the product(s) being applied. Application rate processor 152 can then identify the volume of nutrient being applied to different geographic locations in field 104. Further, if the application rate data and product data correspond to an application of nutrient(s) to field 104 that took place in the past, then application rate processor 152 can generate an output indicative of how much of each nutrient was applied at each different geographic location in field 104 based upon the past application. If the application rate and product data correspond to a future application of nutrient(s) to field 104, then application rate processor 152 can generate an output indicative of the volume of each nutrient that will be applied to the different geographic locations in field 104 during that future application.

Geo-referencing system 154 can generate geographic location values corresponding to the different nutrients indicative of the volume of nutrient that has been applied in the past, that is currently being applied, or that will be applied in the future, to the different geographic locations in field 104. Therefore, the outputs from product data analysis component 150 and application rate processor 152 can be used by geo-referencing system 154 to generate an output indicative of geo-referenced nutrient values.

Given the geo-referenced nutrient values, nutrient use processing system 128 can identify nutrient use efficiency (NUE) values corresponding to field 104. Current and historic nutrient data aggregator 158 can obtain the nutrient values generated by nutrient data collection system 126 and aggregate both the current and historic nutrient use values to obtain a nutrient use metric indicative of the volume of each nutrient that has been applied across field 104 historically, that may be applied currently, and/or that may be applied during a future application. Yield data accessing system 160 obtains yield values indicative of a historic yield, a current yield, and/or an estimated future yield at the different locations across field 104. Geo-referenced NUE metric generator 162 then generates geo-referenced NUE metric values 178 for the different locations across field 104 based upon the volume of nutrients at those geographic locations and the yield corresponding to those geographic locations. The geo-referenced NUE metric values may thus be generated as historic geo-referenced NUE metric values, as current geo-referenced NUE metric values, or as future estimated geo-referenced NUE metric values.

Target NUE metric generator 164 generates an output indicative of a target NUE metric value (or desired NUE metric value) 180 for the different geographic locations across field 104. The target or desired NUE metric values 180 can be obtained through an operator input from operator 168, or retrieved from data store 118, or obtained in other ways. The NUE metric values 178 generated by geo-referenced NUE metric generator 164 and the target NUE metric values 180 generated by target NUE metric generator 164 can then be used by nutrient prescription generator 130 to generate a nutrient prescription that can be used by an agricultural machine 102 to apply fertilizer(s) to field 104.

Given the geo-referenced NUE metric values 178 and the target or desired geo-referenced NUE metric values 180, nutrient prescription generator 130 generates a geo-referenced nutrient prescription 182 indicative of how much product is to be applied by agricultural machine 102, or a different agricultural machine, to the different geographic locations in field 104. Control system 132 can then generate control signals based upon the geo-referenced nutrient prescription 182 to control the actuators on agricultural machine 102 to apply the product according to the geo-referenced nutrient prescription 182. For instance, control system 132 can generate control signals to control the application system actuators 174 on agricultural machine 102 to apply product(s) at a desired rate to meet the geo-referenced nutrient prescription 182. For instance, as agricultural machine 102 moves across field 104, based upon the sensor signal from position sensor 142, and based upon the geo-referenced nutrient prescription 182, control system 132 can generate the appropriate control signals to control the application system actuators 174 to achieve the desired geo-referenced nutrient prescription 182.

As an example, it may be that the geo-referenced NUE metric values 178 are below the target or desired geo-referenced NUE metric values 180 at a particular geographic location in field 104. In that case, nutrient prescription generator 130 can generate the geo-referenced nutrient prescription 182 to adjust the rate at which fertilizer is applied (given the content of nutrients in the fertilizer) to adjust the volume of nutrient applied at that geographic location in order to increase the NUE metric values to more closely conform to the target NUE metric values. In another example, it may be that the target or desired geo-referenced NUE metric values 180 are similar enough to the actual geo-referenced NUE metric values 178 that the geo-referenced nutrient prescription 182 need not add a large quantity of nutrients at that geographic location. Nutrient prescription generator 130 thus determines, based upon the geo-referenced NUE metric values 178 and the target or desired geo-referenced NUE metric values 180, whether more nutrients should be applied at a given geographic location or whether less nutrients should be applied at a given geographic location so that the NUE metric values 178, after nutrient application, will more closely conform to the target or desired geo-referenced NUE metric values 180.

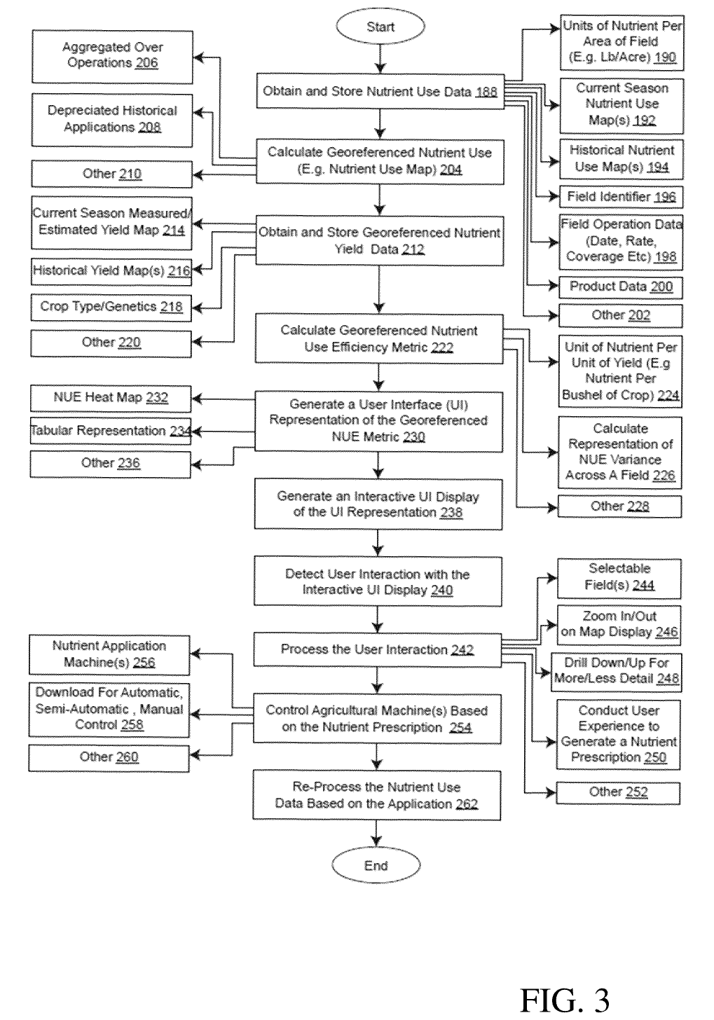

FIG. 3 is a flow diagram illustrating one example of the operation of agricultural system 100, and nutrient processing and control system 108, in more detail. It is first assumed that nutrient data collection system 126 obtains and stores nutrient use data indicative of the volume of nutrients that have been used across field 104, as indicated by block 188 in the flow diagram of FIG. 3. The nutrient use data can be defined in terms of units of nutrient per area of the field (e.g., pounds per acre), as indicated by block 190 in the flow diagram of FIG. 3. The nutrient data may identify nutrient use (e.g., the volume of nutrient applied) during a current season on a nutrient use map which maps the volume of different nutrients applied across different locations on field 104, as indicated by 192. The nutrient use data may be historical nutrient use data that can include a historical nutrient use map that maps the volumes of nutrients applied across field 104 historically (such as over previous growing seasons, etc.), as indicated by block 194. The nutrient data may include a field identifier 196 that identifies the field 104 for which the nutrient data was obtained. The field data may include a field operation identifier that identifies a particular operation during which nutrients were applied to the field. The field operation data may include such items as the date of the operation, the application rate corresponding to the operation, the field coverage corresponding to the operation, etc., as indicated by block 198. The nutrient data may include product data 200 that identifies a particular product that was applied, during one or more operations, to field 104. The nutrient use data can include other data or be obtained or generated in other ways as well, as indicated by block 202.

Nutrient data collection system 126 then uses geo-referencing system 154 to calculate geo-referenced nutrient use data, such as a nutrient use map (if not already received), that identifies the volume of nutrients that have been used across different geographic locations in field 104, as indicated by block 204. Current and historic nutrient data aggregator 158 can then aggregate the current and historical nutrient use data. The geo-referenced nutrient use data may be aggregated over a plurality of different operations, as indicated by block 206, over a plurality of different growing seasons, and/or over a plurality of different crops. The nutrient use data may also be depreciated. For instance, where nutrients were applied during one or two previous growing seasons, those nutrients may have been lost through a variety of natural processes. Therefore, the volume of nutrients applied during a previous growing season may be depreciated by a loss amount that may be indicative of the volume of that nutrient that has been lost since it was applied. Generating the geo-referenced nutrient data accounting for historical depreciation is indicated by block 208. The geo-referenced nutrient use data can be obtained in other ways as well, as indicated by block 210.

Yield data accessing system 160 then obtains and stores geo-referenced yield data for the field 104, as indicated by block 212 in the flow diagram of FIG. 3. The yield data can be values obtained for a current growing season by measuring the yield during harvesting or by estimating the yield using aerial images or in other ways, and by plotting the yield values on a map to obtain a yield map, as indicated by block 214. The yield values may be generated from historical yield maps, as indicated by block 216. The yield values may include a crop type indicator identifying the crop type and/or a hybrid or genetics indicator identifying the hybrid or genetics of the crop, as indicated by block 218. The yield data can include any of a wide variety of other yield data that identifies the yield across field 104 (e.g., in terms of bushels per acre, etc.), or in other ways, as indicated by block 220.

Geo-referenced NUE metric generator 162 then calculates a geo-referenced nutrient use efficiency metric (or set of metrics) for field 104, as indicated by block 222. The geo-referenced nutrient use efficiency metrics can be generated in the form of a geo-referenced nutrient use efficiency map and may identify the nutrient use efficiency in terms of units of nutrients per unit of yield (e.g., pounds of nutrient per bushel of crop) corresponding to a particular geographic location in field 104, as indicated by block 224. Geo-referenced NUE metric generator 162 can also calculate a value representative of the variance of the nutrient use efficiency metric value across field 104, as indicated by block 226. The nutrient use efficiency metrics can be calculated and geo-referenced in other ways as well, as indicated by block 228.

In one example, the geo-referenced NUE metric values 178 are provided to control system 132 which generates a control signal to control operator interface system 124 to generate a user interface (UI) representation of the geo-referenced NUE metric values, as indicated by block 230 in the flow diagram of FIG. 3. The UI representation of the geo-referenced NUE metric values can be generated in the form of an NUE heat map as indicated by block 232 in FIG. 3 or as a tabular representation as indicated by block 234 in FIG. 3, or in a wide variety of other ways 236.

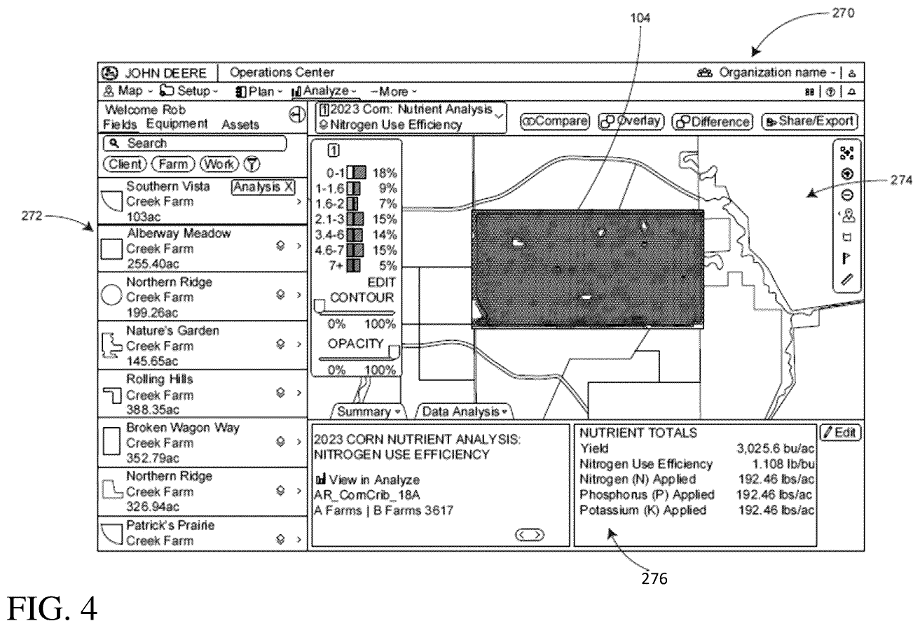

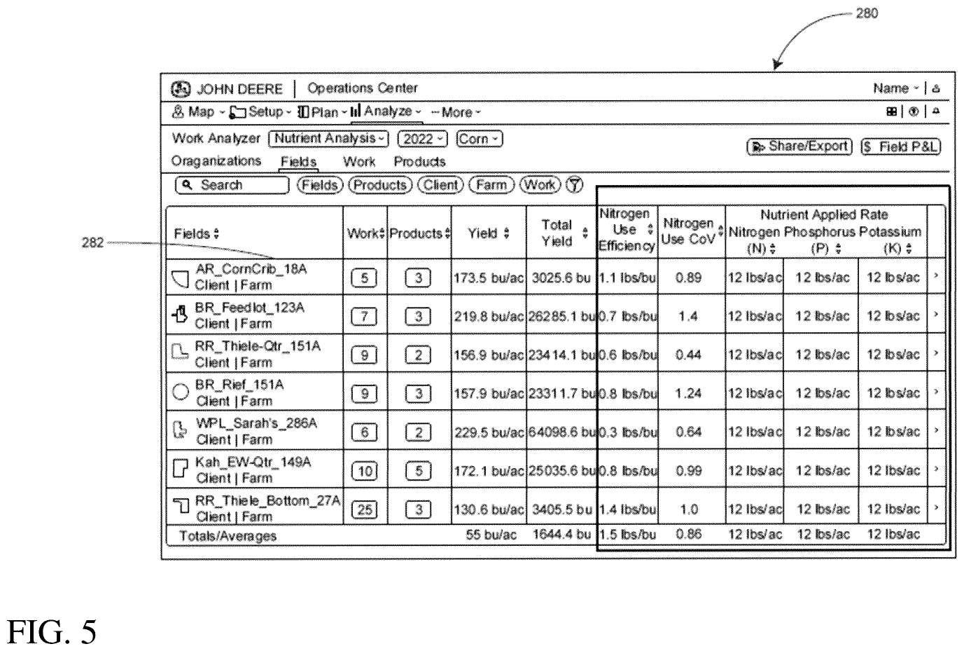

The UI representation can then be displayed as an interface 170 by operator interface system 124 for operator 168. The UI may be an interactive UI in which case operator 168 can interact with the UI representation of the geo-referenced NUE metric values. Generating an interactive UI display of the representation of the geo-referenced NUE metric values is indicated by block 238 in the flow diagram of FIG. 3, and some examples of UI displays are discussed below with respect to FIGS. 4 and 5.

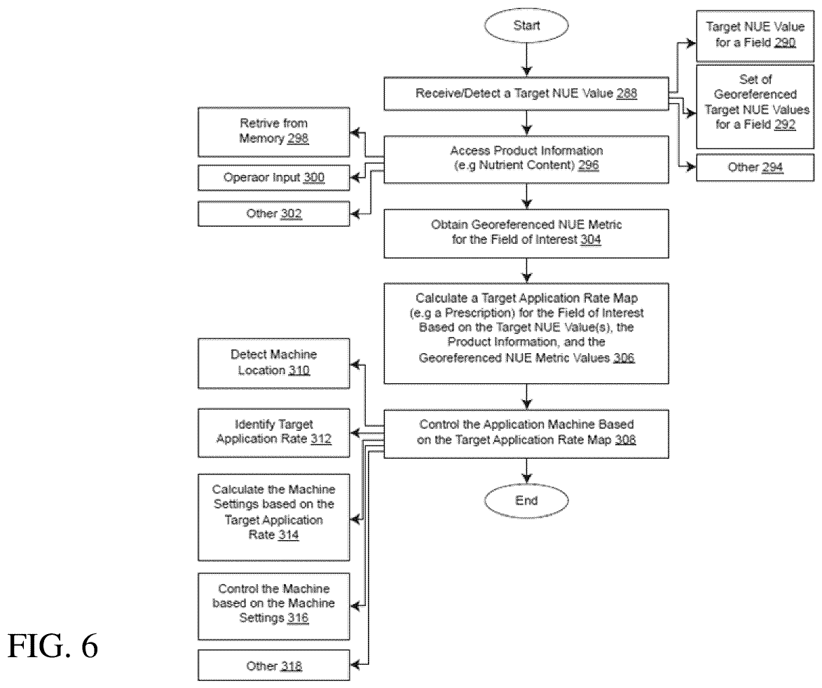

Operator interface system 124 can then detect user interaction with the interactive UI display, as indicated by block 240. Nutrient processing and control system 108 can then process the user interaction as indicated by block 242. For instance, the UI display may have a plurality of selectable field indicators that allow operator 168 to select a particular field for viewing the geo-referenced NUE metric values, as indicated by block 244 in the flow diagram of FIG. 3. The UI representation may have actuators that allow operator 168 to zoom in or out on a map of NUE metric values to view more granular or more course data on a map, as indicated by block 246 and the flow diagram of FIG. 3. The UI representation may include actuators that allow operator 168 to drill up or down to view more or less detail on the UI representation, as indicated by block 248 in the flow diagram of FIG. 3. Further, operator interface system 124 may be configured to conduct a user interface experience that prompts operator 168 to enter information so that a nutrient prescription generator 130 can generate a geo-referenced nutrient prescription 182 for the field 104, as indicated by block 250. Generating a geo-referenced nutrient prescription 182 is described in greater detail below with respect to FIG. 6. Various other user interactions on the UI representation can be processed in other ways as well, as indicated by block 252.

When a geo-referenced nutrient prescription 182 is generated, then control system 132 can control one or more different agricultural machines based upon the geo-referenced nutrient prescription, as indicated by block 254. For instance, where the agricultural machine 102 is a nutrient application machine, then control system 132 can generate control signals to control the nutrient application machine based upon the prescription 182, as indicated by block 256. Control system 132 may control communication system 120 or another system to download the geo-referenced nutrient prescription 182 to a desired agricultural machine so that the agricultural machine can perform automatic, semi-automatic, or manual control to apply product(s) according to the downloaded prescription 182, as indicated by block 258. Control system 132 can control any of a wide variety of other agricultural machines in other ways based upon the prescription 182, as indicated by block 260.

When product(s) has been applied to a field based on the geo-referenced nutrient prescription 182, then data indicative of how much product was applied across field 104 can be provided back to nutrient data collection system 126 so that the historic nutrient data 134 and the current nutrient data 136 can be updated based upon the newest application of product to field 104. Processing the nutrient use data based upon the current nutrient application is indicated by block 262 in the flow diagram of FIG. 3.

FIG. 4 shows one example of a UI display 270 that can be generated based upon the geo-referenced NUE metric values 178. UI display 270 includes a list of field selectors shown generally at 272. The field selectors 272 can be actuated by an operator 168 to select a field for which the geo-referenced NUE metric values 178 are to be viewed. Once a field is selected, FIG. 4 shows that a geo-referenced NUE heat map 274 is displayed for viewing by operator 168. Heat map 274 shows a color-coded map of field 104. The color coding identifies the geo-referenced NUE metric values 178 at different geographic locations across field 104. It will be appreciated that operator 168 may be able to interact with UI display 270 to zoom into or out of the display of field 104. In addition, in the example shown in FIG. 4, UI display 270 may include a detailed display region 276 that shows additional details corresponding to field 104. Those details may include such things as yield, nitrogen use efficiency, the volume of different nutrients applied (nitrogen, phosphorus, potassium, etc.), as well as an overall nutrient use efficiency metric value for field 104 or for a selected location in field 104. UI display 270 can include a wide variety of different or additional information as well, and the information shown in FIG. 4 is shown for the sake of example only.

FIG. 5 shows one example of a user interface display 280 that shows information in tabular form. Display 280 includes a set of field selectors 282 that can be selected by operator 168 to select a particular field. The tabular representation shown in display 280 can include information identifying the different products that have been applied to the field, the yield corresponding to the field, the nutrient efficiency metric values corresponding to the field, the variance of the nutrient use efficiency metric values across the field, the rates of application for various nutrients, the specific use efficiency scores corresponding to specific nutrients (such as nitrogen use efficiency, etc.), among a wide variety of other things.

It will be appreciated that while FIGS. 4 and 5 show different examples of UI representations that can be generated to show the nutrient use efficiency metric values, and other information corresponding to applied nutrients, the examples shown in FIGS. 4 and 5 are examples only. There are a wide variety of other UI representations that can be generated, with other interactive actuators that can be actuated by an operator 168 to perform other operations.

FIG. 6 is a flow diagram showing one example of the operation of nutrient processing and control system 108 in generating a geo-referenced nutrient prescription 182 for a field 104. It is first assumed that nutrient prescription generator 130 receives target or desired geo-referenced NUE metric values 180 for the field, as indicated by block 288 in the flow diagram of FIG. 6. The target NUE metric values can be for an entire field 104, or a set of geo-referenced target NUE metric values across a field 104, as indicated by blocks 290 and 292. The target NUE metric values 180 can be received or obtained in other ways as well, as indicated by block 294.

Nutrient prescription generator 130 then accesses product information which may be output by product data analysis component 150 or accessed from data store 118 or received from an operator 168. Accessing product information indicative of the nutrient contents of a product(s) to be applied to field 104 is indicated by block 296. Retrieving the product information from data store 118 or other memory is indicated by block 298. Receiving the product information from an operator input is indicated by block 300. The product information can be received in a wide variety of other ways as well, as indicated by block 302.

Nutrient prescription generator 130 then obtains the geo-referenced NUE metric values 178 for the field of interest, as indicated by block 304 in the flow diagram of FIG. 6. Nutrient prescription generator 130 then calculates a target application rate map (e.g., a prescription) for the field of interest based upon the target NUE metric values, the product information, and the geo-referenced NUE metric values 178 for the field of interest. Calculating a target application rate map for the field of interest (e.g. a geo-referenced nutrient prescription) is indicated by block 306 in the flow diagram of FIG. 6.

For instance, if the nutrient use efficiency for the field is currently low, then this may indicate that either the volume of nutrients applied to the field is no longer increasing the yield from the field at a desired rate, or there are insufficient nutrients being applied to the field resulting in diminished yield. Based upon the yield values and the nutrient use efficiency values, nutrient prescription generator 130 can generate the prescription to either increase or decrease the rate at which nutrients are applied to the field to obtain a better nutrient use efficiency metric value.

Control system 132 can then control the application machine based upon the target application rate map (e.g., based upon the geo-referenced nutrient prescription), as indicated by block 308 and the flow diagram of FIG. 6. To control the agricultural machine applying product(s) to the field, control system 132 can detect the machine location based upon output from position sensor 142, as indicated by block 310. Control system 132 can then identify the target application rate from the target application rate map, given the location of the machine, and calculate the machine settings that are needed to obtain the target application rate identified on the target application rate map. Identifying the target application rate from the current position of the machine and from the target application rate map is indicated by block 312, and calculating the machine settings based upon the identified target application rate is indicated by block 314. The settings can then be applied on the machine to control the machine based upon those settings, as indicated by block 316. The application machine can be controlled in a wide variety of other ways as well, as indicated by block 318.

It can thus be seen that the present description describes a system that identifies nutrients applied to a field, or nutrients that will be applied to a field, and correlates the applied nutrients to crop yield from the field. The correlation can be used to generate a nutrient use efficiency score or nutrient use efficiency metric value for any of a wide variety of different nutrients. That nutrient use efficiency score can be surfaced for an operator 168 or a user of another system. The nutrient use efficiency scores can be geo-referenced to different locations in a field. The geo-referenced nutrient use efficiency scores can be used to generate prescriptions for applying product(s) to the field, and for controlling product application machines to apply product(s) to the field. The geo-referenced nutrient use efficiency scores can also be used in other ways to manage efficient application of nutrients to the field to avoid over applying or under applying the nutrients.

The present discussion has mentioned processors and servers. In one example, the processors and servers include computer processors with associated memory and timing circuitry, not separately shown. The processors or servers are functional parts of the systems or devices to which they belong and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, and/or logic. It will be appreciated that such systems, components, generators, and/or logic can be comprised of hardware items (such as processors and associated memory, or other processing components, some of which are described below) that perform the functions associated with those systems, components, generators, and/or logic. In addition, the systems, components, generators, and/or logic can be comprised of software that is loaded into memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, and/or logic described above. Other structures can be used as well.

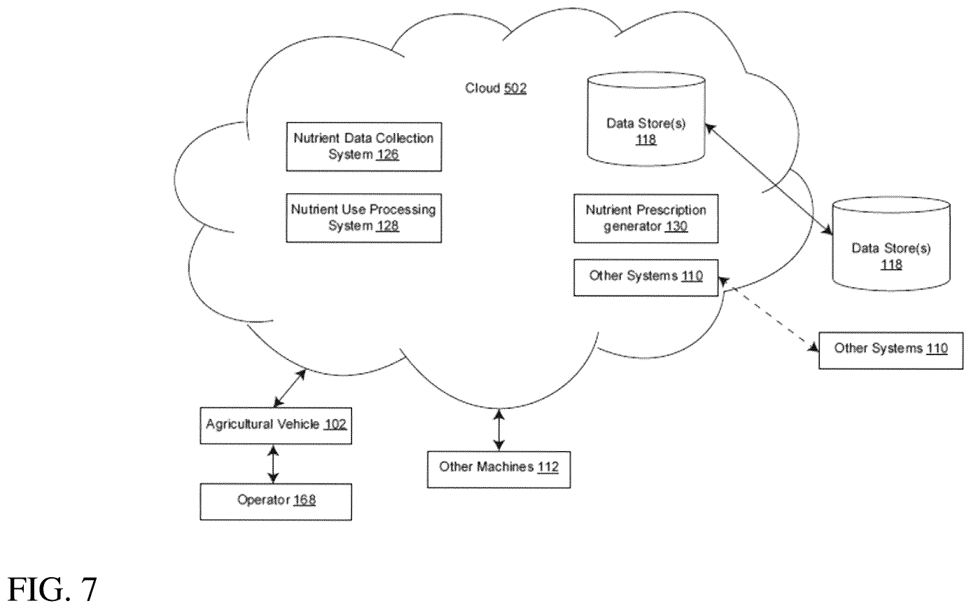

FIG. 7 is a block diagram of system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 7, some items are similar to those shown in previous FIGS. and they are similarly numbered. FIG. 7 specifically shows that nutrient data collection system 126, nutrient use processing system 128, nutrient prescription generator 130, other systems 110, and data store 118 can be located at a remote server location 502. Therefore, these items can be accessed through remote server location 502.

FIG. 7 also depicts another example of a remote server architecture. FIG. 7 shows that it is also contemplated that some elements of previous FIGS are disposed at remote server location 502 while others are not. By way of example, data store 118 or other systems 110 can be disposed at a location separate from location 502, and accessed through the remote server at location 502. Regardless of where the items are located, they can be accessed directly by system 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

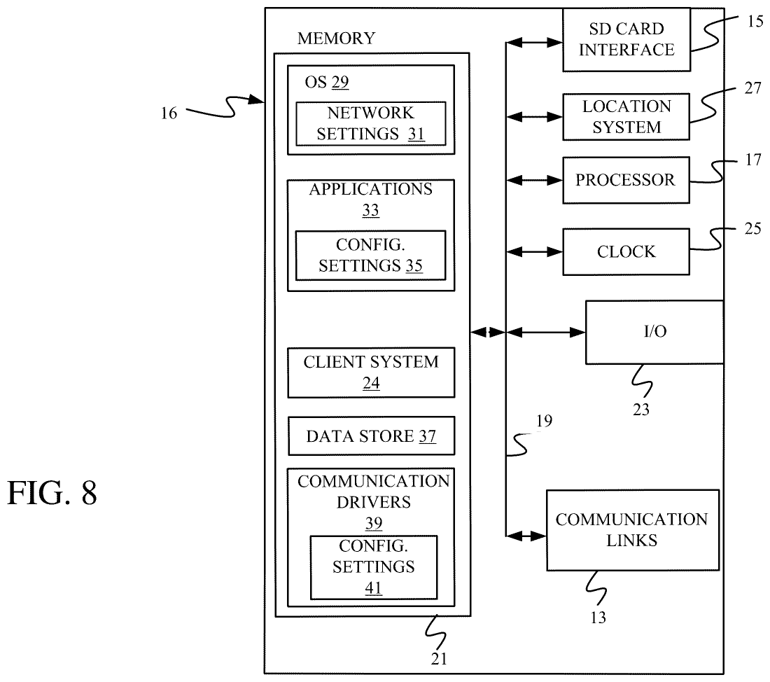

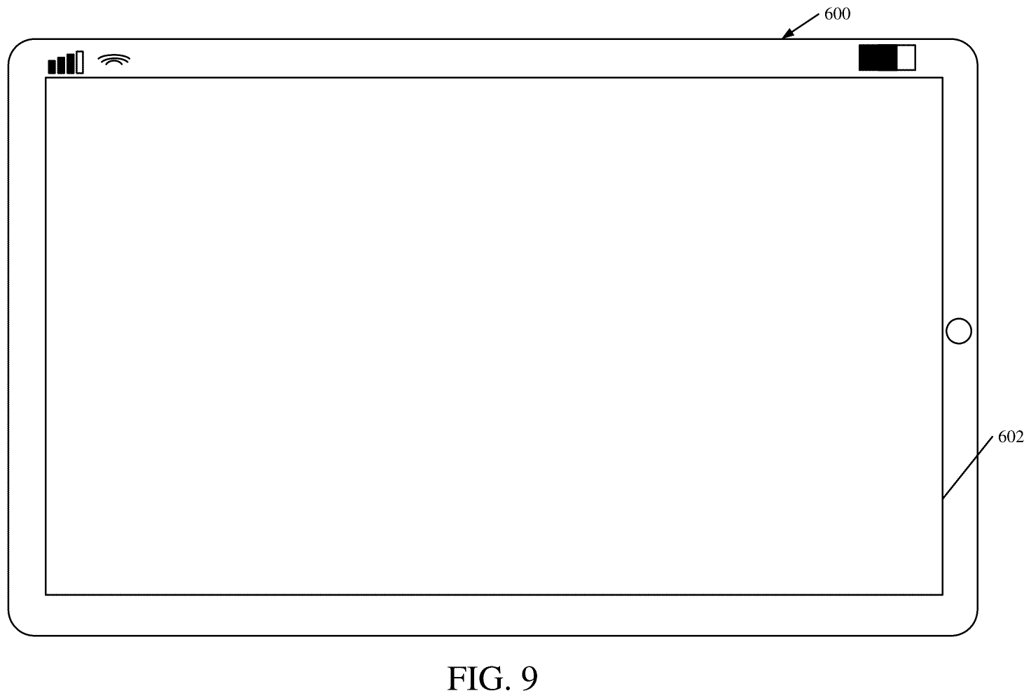

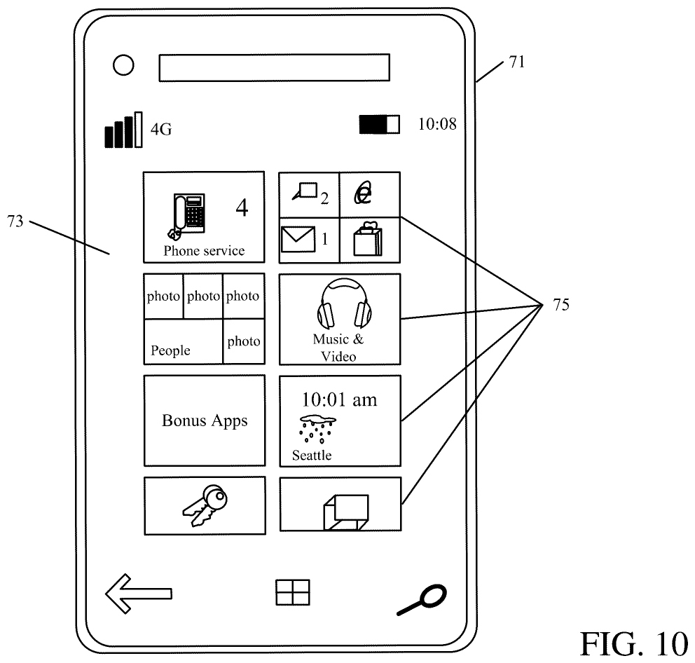

FIG. 8 is a simplified block diagram of one illustrative example of a handheld or mobile computing device that can be used as a user's or client's hand held device 16, in which the present system (or parts of it) can be deployed. For instance, a mobile device can be deployed in the operator compartment of agricultural machine 102 for use in generating, processing, or displaying the stool width and position data. FIGS. 9-10 are examples of handheld or mobile devices.

FIG. 8 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographic location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 9 shows one example in which device 16 is a tablet computer 600. In FIG. 9, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

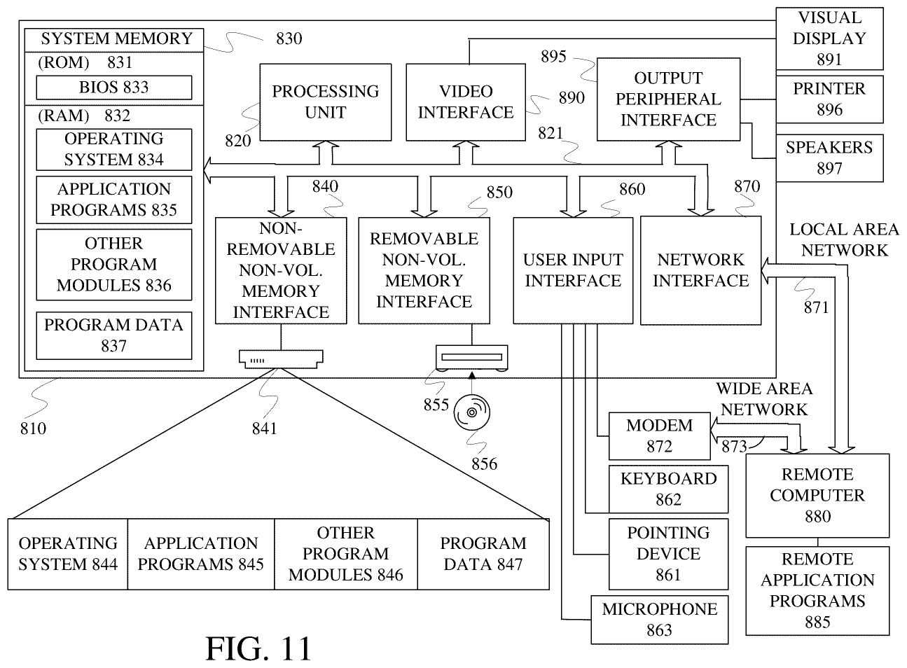

FIG. 11 is one example of a computing environment in which elements of previous FIGS., or parts of it, (for example) can be deployed. With reference to FIG. 11, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network-WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 11 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed IS:

1. A computer implemented method, comprising:
obtaining geo-referenced nutrient use data corresponding to a field;
obtaining geo-referenced yield data corresponding to the field;
generating a geo-referenced nutrient use efficiency (NUE) metric value for the field based on the nutrient use data and the yield data; and
based on the NUE metric value, generating a control signal to control an agricultural system.

2. The computer implemented method of claim 1 wherein generating a control signal comprises:
generating the control signal to generate an output indicative of the NUE metric value on a remote server system.

3. The computer implemented method of claim 1 wherein generating a control signal comprises:
generating a nutrient prescription for the field based on the NUE metric value.

4. The computer implemented method of claim 3 wherein generating a control signal comprises:
generating the control signal to control a nutrient application machine based on the nutrient prescription.

5. The computer implemented method of claim 3 wherein generating an NUE metric value comprises:
generating a current NUE metric value for the field; and
generating a target NUE metric value for the field based on the current NUE metric value.

6. The computer implemented method of claim 5 wherein generating a current NUE metric value comprises:
generating a set of geo-referenced current NUE metric values for the field.

7. The computer implemented method of claim 6 wherein generating a target NUE metric value comprises:
generating a set of geo-referenced target NUE metric values for the field based on the set of geo-referenced current NUE metric values for the field.

8. The computer implemented method of claim 7 wherein generating the nutrient prescription comprises:
accessing product data indicative of nutrient content in a product;
obtaining the set of geo-referenced NUE metric values for the field; and
calculating a geo-referenced application rate based on the target NUE metric values and the nutrient content of the product.

9. The computer implemented method of claim 1 wherein generating the NUE metric value comprises:
generating the NUE metric value expressed in terms of units of nutrient use and units of yield.

10. The computer implemented method of claim 1 wherein obtaining nutrient use data comprises:
accessing historical nutrient use data indicative of historical nutrient application, the historical nutrient use data being depreciated based on a length of time since nutrient application.

11. The computer implemented method of claim 10 wherein obtaining yield data comprises:
accessing historical yield data indicative of historical harvest operations; or obtaining estimated yield data indicative of estimated yield for the field.

12. An agricultural system, comprising:
a nutrient use efficiency (NUE) system configured to obtain nutrient use data corresponding to a field and yield data corresponding to the field;
a NUE generator configured to generate an NUE metric value for the field based on the nutrient use data and the yield data;
a controllable system; and
a control signal generator configured to generate a control signal to control the controllable system based on the NUE metric value.

13. The agricultural system of claim 12 wherein an application machine applies a product to the field and further comprising:
a product data accessing system configured to access product data indicative of nutrient content of the product.

14. The agricultural system of claim 13 wherein the NUE generator comprises:
a current NUE system configured to generate a set of geo-referenced current NUE metric values for the field; and
a target NUE system configured to generate a set of geo-referenced target NUE metric values for the field.

15. The agricultural system of claim 14 wherein the control signal generator comprises:
a prescription generator configured to calculate a geo-referenced application rate for the field based on the set of target NUE metric values, the set of geo-referenced current NUE metric values, and the nutrient content of the product to be applied.

16. The agricultural system of claim 15 wherein the control signal generator is configured to generate the control signal to control a nutrient application machine based on the geo-referenced application rate.

17. The agricultural system of claim 12 wherein the control signal generator is configured to generate the control signal to generate an output indicative of the NUE metric value on a remote server system.

18. The agricultural system of claim 12 wherein the NUE system is configured to access historical nutrient use data indicative of historical nutrient application, the historical nutrient use data being depreciated based on a length of time since nutrient application, and to obtain at least one of historical or estimated yield data indicative of estimated yield for the field.

19. A computer system, comprising:
at least one processor; and
a data store storing computer executable instructions which, when executed by at least one processor, cause the at least one processor to perform a method, comprising:
obtaining nutrient use data corresponding to a field;
obtaining yield data corresponding to the field;
generating a set of geo-referenced nutrient use efficiency (NUE) metric values for the field based on the nutrient use data and the yield data; and
generating a control signal in a remote server system to control the remote server system based on the set of geo-referenced NUE metric values.

20. The computer system of claim 19 wherein generating a control signal comprises:
generating the control signal to generate an output indicative of the NUE metric values on a remote server system.
